(19) United States
(12) Patent Application Publication
(10) Pub. No.: US 2026/0226999 A1
(43) Pub. Date: Aug. 6, 2026

(54) HIGH FLOW INTELLIGENT POSITIONER

(71) Applicant: STI S.R.L., Levate (BG) (IT)

(72) Inventors: Flavio Tondolo, Levate (BG) (IT); Mirko Coffetti, Levate (BG) (IT)

(73) Assignee: STI S.R.L., Levate (BG) (IT)

(21) Appl. No.: 19/156,334

(22) PCT Filed: Mar. 4, 2024
(86) PCT No.: PCT/IB2024/052077

§ 371 Date: Aug. 13, 2025

(30) Foreign Application Priority Data
Mar. 6, 2023 (IT) 10202300004002

(51) Int. Cl. F16K 31/42; F16K 31/126

(52) U.S. Cl. CPC F16K 31/42; F16K 31/1262

(57) ABSTRACT

A valve positioner to control the flow of a fluid within a circuit and, more particularly, a new “intelligent” positioner with high flow capacity. The positioner includes a control unit, equipped with a microprocessor having an integrated FRAM type memory, which allows easier data management and the implementation of new functions. The microprocessor is also configured to further manage contactless sensors.

### RELATED APPLICATIONS

This is a national stage application of PCT application PCT/IB2024/052077 having an international filing Date of Mar. 4, 2024 This application claims foreign priority based on application 102023000004002 filed on Mar. 6, 2023.

### FIELD OF THE INVENTION

The present invention relates to the control of the flow of a fluid within a circuit and, more particularly, to a positioner with high flow capacity.

### BRIEF DESCRIPTION OF THE PRIOR ART

As is known, a control valve regulates the flow of a fluid (for example: gas, steam, water or chemical compounds) that passes through a circuit of any industrial and civil plant. Such a fluid is typically called a process fluid. The regulation of this process fluid can take place by means of an actuator which, through the control fluid present in the actuator circuit, provides the driving force necessary to open or close the control valve.

It is also known that a control valve positioner is an actuator-mounted device that can manage the flow of the control fluid by means of a control strategy, developed using algorithms managed by a microprocessor. More recently, control valve positioners have been significantly improved, due also to the use of digital devices, capable of monitoring key variables and implementing more complex control and data recording algorithms.

In practice, a site signal generator (linked to the process control and coming from the control room, by means of any digital communication protocol) provides a variable current signal to the control valve positioner, which signal is proportional to the percentage desired opening of the valve and therefore it identifies the required position. For example, the positioner may interpret as requested position the fully opening the valve in response to a 4 mA current input signal, and it may interpret a request for fully closing the valve in response to a 20 mA current input signal.

The positioner then compares the current input signal with the actual position signal of the actuator (measured through a position feedback) and, based on the control strategy determined by the microprocessor, it manages the flow of the control fluid, and therefore the necessary driving force to move the actuator accordingly. As an example, if the current input signal is different from the actual position signal of the actuator, the valve positioner generates a flow of control fluid, capable of moving the actuator to the required position: such a comparison between the two signals is repeated continuously, thus generating an effect on the flow of the control fluid such as to reduce the discrepancy between the actual position of the actuator and that requested by the control room.

Specifically, positioners for pneumatic actuators are concerned, in particular:
pneumatic positioner for single-acting actuator, capable of sending or discharging the pressurized control fluid (air) to a single chamber of the actuator (in the other chamber of the actuator an elastic element applies the reaction force, in opposition to that generated from the control fluid),
pneumatic positioner for double-acting actuator, capable of sending or discharging the pressurized control fluid (air) to both chambers of the actuator.

The design of a positioner and the operating principle are well known in the art. Patent EP 2238377 B1 of the undersigned, for example, describes in great detail the main components of a high flow capacity positioner and the related operating principle. The positioner described therein is a complex system, which includes various components inseparably related to each other:
a spool assembly, used to modify the flow of the pressurized control fluid to be sent to the actuator chamber(s);
a position sensor, used to detect moment by moment the actual position of the actuator;
a control unit with programmable algorithms, equipped with a microprocessor, which processes input data and values measured by the position sensor, in order to provide an output current signal;
an electro-pneumatic transducer, which converts the current signal output from the control unit into pressure, used for the actuation of the spool assembly;
a casing, which contains all the components described and which is provided with a plurality of openings and internal ducts, useful for sending or discharging the pressurized control fluid;
a plurality of lids, which have the task of preventing water and impurities from entering the positioner.

Following the dictates of the patent, the applicant has produced for several years this type of positioned, which has achieved considerable commercial success. However, over the years some drawbacks have emerged which require a new design of the positioner.

A first limitation of known positioners is linked to the inability to manage “big data” flows in the presence of high response dynamics. Obviously, in general terms, the shorter is the time elapsing between the request of movement and the actual positioning, the better is the regulation. The speed with which a positioner can make the actuator-valve assembly move up to the requested position theoretically depends on the capacity range of the positioner. Analyzing a typical positioning step, let us imagine an actuator stable at the requested point A and that the position request becomes B.

The sequence of events (starting from signal A, position A, zero speed, zero control fluid flow) is:
1. Acquisition of the new signal requiring position B
2. Acquisition of the effective position with continuity
3. Comparison between actual position and requested position
4. Processing of the current signal which will generate the movement of the spool, in order to assume position B as soon as possible
5. Physical movement of the spool which generates the flow of the control fluid which, in turn, generates the movement of the actuator towards position B
6. Processing while continuously moving the points above.

Any latency/delay on the steps described above will inevitably cause delay in the action and/or instability of the system, in the attempt to stop at point B. Obviously, the processing of the current signal which has the task of generating the movement of the spool takes place according to programs and algorithms that take into account the reaction time of each single step 1-6 and which, to compensate for latencies and avoid instability, slow down the movement dynamics of the actuator, by limiting the flow rate of the control fluid managed by the positioner.

As an example, reference can be made to the acquisition and decoding of the signal coming from the position sensor. As is known, a signal acquired in real time includes within itself any disturbances that can be generated by noise and/or interference linked to various physical phenomena, which can negatively impact the precision and performance of the closed loop control system. A signal filtering system is sometimes necessary to reduce to a minimum the influence of disturbances on the control system. This will allow, on a theoretical level, to obtain a perfectly clean signal, but, at the same time, it will introduce delays in the sequence of events introduced previously, thus invalidating the dynamic response of the positioning system, the main strong point of a system high flow rate and high dynamics. The quicker the positioner is to modulate its flow rate, i.e. the flow rate of the control fluid (finding the optimal value moment by moment), the higher this flow rate can be. As a consequence, fast, precise and stable regulation can be maintained.

It is clear that in order to have these characteristics (fast modulation of the flow rate of the control fluid and high flow rate of the control fluid) a positioner must necessarily have high electronic reading and internal control dynamics.

A second limitation of known positioners is linked to the inability to manage a large amount of data, in order to monitor historical events which from a diagnostic point of view represent essential information.

A further limitation is linked to the technological development of sensors, in particular position sensors without mechanical contact (or “contactless”), which at present are not managed by traditional microprocessors.

Furthermore, the electromechanical transducer does not guarantee correct functioning in all directions of space, forcing users to carry out difficult calibration procedures of the elastic elements.

Finally, the spool assembly requires mechanical improvements to improve its reliability in the face of higher performance required by the control unit.

There is therefore the need to define a new positioner that overcomes the described drawbacks.

### SUMMARY OF THE INVENTION

Main purpose of the present invention is achieved by the definition of a new “intelligent” positioner with high flow capacity. The positioner includes a control unit, equipped with a microprocessor having an integrated FRAM type memory, which allows easier data management and the implementation of new functions. The microprocessor is also configured to further manage contactless sensors.

Advantageously, the positioner is also equipped with at least one contactless magnetic position sensor and a “contactless” I/P (current-pressure) transducer of the magnetic type. This is to avoid the use of moving parts in contact in these components and to guarantee good functioning according to all possible orientations of the positioner in space.

Finally, the positioner according to the present invention is equipped with a spool assembly, casing and lids optimized according to multiple mechanical and pneumatic aspects necessary to adapt the performance to the most demanding requests dictated by the control unit.

These and other purposes and advantages are achieved, according to the invention, by an “intelligent” high-flow positioner having the characteristics set out in the attached independent claim.

Further preferred and/or particularly advantageous embodiments of the invention are described according to the characteristics set out in the attached dependent claims.

### BRIEF DESCRIPTION OF THE DRAWINGS

The invention will now be described with reference to the attached drawings, which illustrate a non-limiting example of implementation, in which:

FIG. 1 is a longitudinal section of a positioner according to an embodiment of the present invention,

FIG. 2 is an exploded view of the positioner in FIG. 1, with the individual functional subgroups highlighted,

FIG. 3 is a section of a “contactless” position sensor and its housing inside the positioner in FIG. 1,

FIG. 4 is a first detail on an enlarged scale of a stem of a spool assembly of the positioner in FIG. 1,

FIG. 5 is a second enlarged detail of a non-return valve of the spool assembly of the positioner of FIG. 1, and

FIG. 6 is an enlarged detail of the positioner casing, in which a quick discharge non-return valve is housed.

### DETAILED DESCRIPTION OF THE PREFERRED EMBODIMENTS

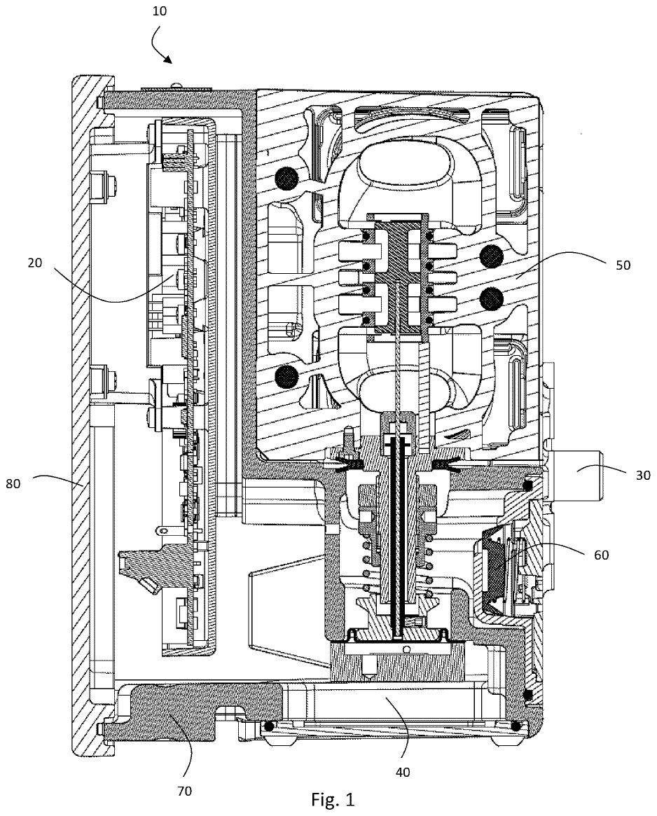

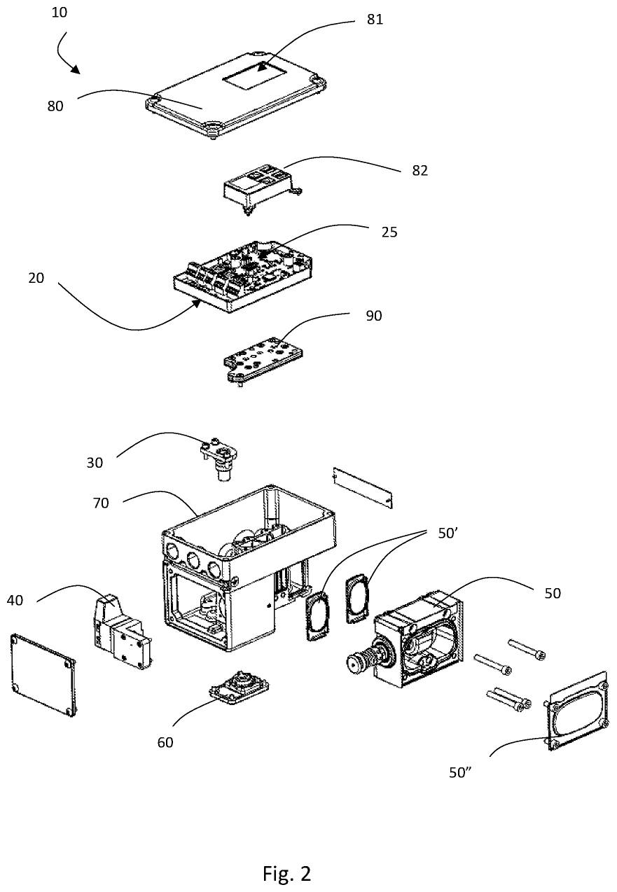

With reference to FIGS. 1 and 2, the positioner 10 according to the present invention is provided with the following main components, inseparably interconnected with each other:
an electronic control unit (hereinafter, only ECU, from the English Electronic Control Unit) 20 equipped with a suitable microprocessor 25 which processes data and external signals and from the sensors and provides external signals and current signal for the variable flow control through a spool,
an electro-pneumatic transducer 40, which converts a current signal into a pressure signal,
at least one position sensor group 30,
a spool assembly 50 which is used to carry the fluid to and from the closing element of the valve, i.e. the actuator (not shown in the figure). The spool assembly 50 is protected from the external environment by a pair of non-return valves, identified by the assembly 50′, also including their housing system inside the casing,
a casing 70 which is provided with a plurality of openings and internal passages to receive, manage and discharge the control fluid, for example air, and which contains the spool assembly together with the component 50″ which also acts as a cover of the assembly spool, a non-return valve 60 with very low exhaust back pressure and low load losses, which allows the effect of the exhaust back pressure on the regulation of the spool position to be reduced to a minimum and which has the task of maintaining the pressure inside the casing lower than 1.1 bar absolute, and the other components of the positioner,
a lid 80.

Further detailed structural characteristics and the functional specifications of the individual components can be found in the aforementioned patent EP 2238377 B1, except as indicated below.

The individual components will be described below, highlighting the inter-relationships that exist between them. Even from this aspect, reference is also made to what is described in document EP 2238377 B1, incorporated by reference.

With reference to FIG. 2, the microprocessor 25 is equipped with at least one integrated memory configured so as to manage “big data” flows in the presence of high process dynamics, and to record such data with high sampling frequencies. These two functions are of strategic importance for a so-called “intelligent” positioner as they allow the implementation and execution of diagnostic and statistical analyses.

In particular, the microprocessor 25 has an integrated memory with a capacity 250% higher than that of known solutions, such as for example the microprocessor described in EP 2238377 B1.

The integrated memory of the microprocessor 25 is of the FRAM type and not of the FLASH type. FRAM or Ferroelectric RAM is a type of non-volatile memory, in which a layer of ferroelectric material guarantees its non-volatility property.

Compared to Flash technology, FRAM memory offers numerous advantages: lower consumption, higher writing speed, a greater number of writing/erasing cycles, higher sampling event recording, easier data management and simplicity in implementing new functions.

Advantageously, the microprocessor 25 can also have an external memory.

Furthermore, the microprocessor 25 has a speed 400% higher than the speed of known microprocessors, for example compared to the microprocessor described in EP 2238377 B1.

Finally, the microprocessor 25 is provided with a “clock” capable of assigning a sequence to the recorded events, with a timing defined by the instant in which the positioner was switched on. The paired watch may have a battery.

ECU 20 control board can integrate a local monitor with capacitive keyboard or can be connected to a remote monitor, such as a personal computer or any portable device equipped with a suitable diagnostic software application.

Additionally, ECU 20 may have either a wired communication port (for example, Ethernet or USB) or a radio wave communication port (for example, wireless).

Preferably, ECU 20 has the ability to manage up to three pressure sensors, even independently of each other, and which therefore allow to control both single-acting and double-acting actuators without having to carry out any physical operation on the hardware system of the positioner.

Advantageously, ECU 20 is capable of decoding various position sensors (magnetic, potentiometric, etc.) and of providing the decoded information to the microprocessor 25.

Finally, ECU 20 is provided with at least one port useful for managing data from a contactless position sensor (for example, a magnetic, linear or rotary position sensor) and a port for managing a potentiometric position sensor. Such ports can both be connected to the respective position sensors, without affecting the operation of the positioner. The position sensors connected to these ports can also be remote, i.e. placed external to the casing 70 of the positioner. Ideally, one of these ports can also be used to manage a position sensor mounted on the spool assembly and not on the actuator.

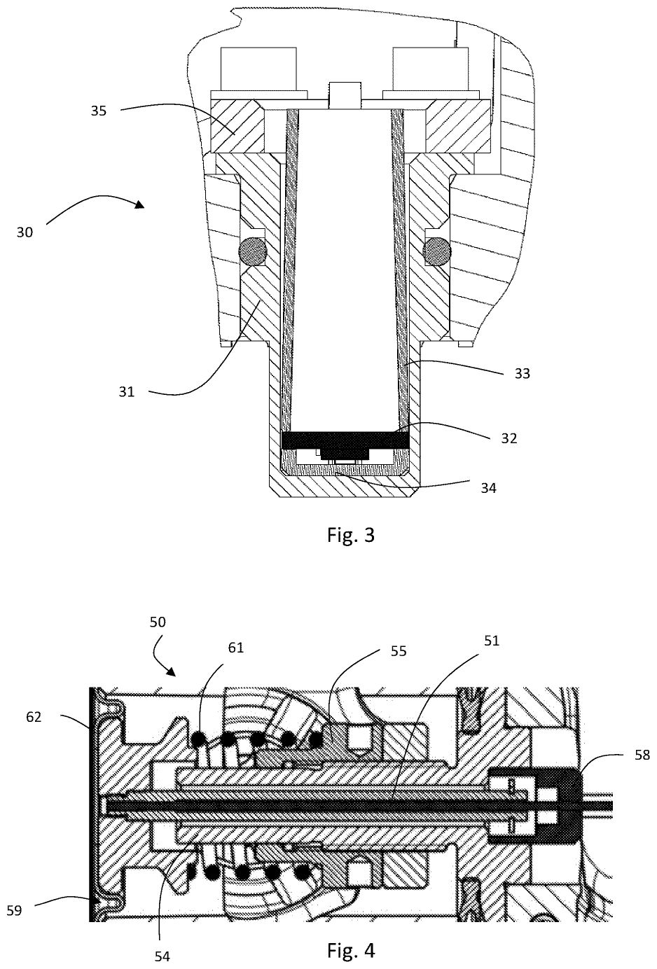

With reference also to FIG. 3, the position sensor assembly 30 is illustrated, comprising a casing 31 made of metallic material, preferably steel, a lid 35 in the form of a plate element, also made of metallic material and a position sensor 32, contained in the casing 31 and held in a predetermined position by a pair of retainers made of polymeric material. The pair of retainers includes a cylindrical sleeve retainer 33 and a bottom retainer 34.

Preferably the at least one position sensor 32 is a “contactless” position sensor of the magnetic type, i.e. without mechanical or other connections. This sensor is able to read the position of the actuator as a function of the variation of an external magnetic field (linked to the position of the actuator). In particular, the external magnetic field could be generated by a magnetic component comprising a perforated bar made of non-magnetic material, in the holes of which small magnetic cylinders are housed along a helical path, as per international patent application WO2021/234615 A1 of the undersigned. The “contactless” position sensor is therefore particularly suitable in the presence of high data sampling requests.

In other embodiments (not illustrated) the at least one position sensor can be a potentiometric sensor or there can be both a potentiometric sensor and a “contactless” sensor. In order to hypothetically use another type of position sensor (potentiometric, etc.), such as for example for applications with high external magnetic fields such as to compromise the operation of the “contactless” position sensor 32, the external housing 31 can be maintained.

With reference to FIG. 2, the electro-pneumatic transducer 40, also called “Pilot” or “I/P Converter”, useful for the conversion of a current signal into a pressure signal, is a “contactless” transducer of the magnetic type, therefore without an elastic reaction element to control the pressure signal.

This solution allows to overcome one of the problems of known applications, described in patent EP 2238377 B1: as the response of the transducer described in patent EP 2238377 B1 can be influenced by its orientation in space, as it is conditioned by the way with which the elastic element is oriented with respect to gravitational forces, the referenced transducer requires a delicate calibration procedure. The magnetic transducer, however, is not affected by its orientation in space, as a magnet replaces the elastic reaction element for controlling the pressure signal. In addition to being more reliable, the magnetic-type “contactless” transducer is itself well suited for the needs of high flow dynamics required by the control unit of the positioner.

With reference to FIGS. 2, 4 and 5, the spool assembly 50 has characteristics that differentiate it from the known technique, for example compared to that described in patent EP 2238377 B1.

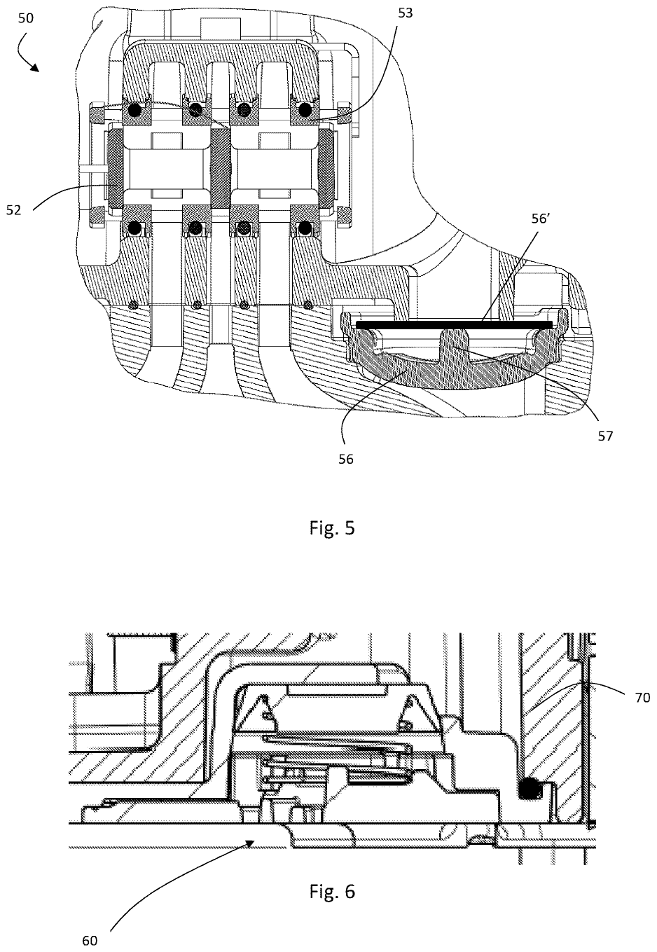

In particular, FIGS. 4 and 5 show in detail the spool assembly 50. This assembly is provided with a stem 51 of the spool 52 which does not have a guide bushing. Therefore, the stem 51 is of the floating type, therefore it is free of sliding friction. This makes it possible to reduce the radial stiffness of the stem 51 with spool 52 assembly and allows the radial loads of the spool 52 on the walls of the cage 53 to be minimized. With this improvement a very high positioning resolution of the spool 52 is obtained, which is important for a positioner with high flow dynamics, an increase in the useful life of the spool 52 and a reduction in the possibility of the spool 52 seizing on the walls of the cage 53.

Furthermore, the problem of having hypothetical impurities trapped between the guide bushing and the sleeve 54 is eliminated, allowing a more fluid handling of the stem 51 and spool 52 and a simplified design of the sleeve 54, which is lightened and does not require particular machining on its external diameter, aimed at ensuring correct sliding of this sleeve 54 in the guide bushing which is no longer present. Therefore the radially external surface of the sleeve 54 will be smooth, i.e. free of machining. The reduction in mass of this sleeve 54 also allows for reduced moving masses, therefore smaller inertia forces on the spool 52 and, consequently, a better ability of the positioner 10 to manage the positioning of the spool 52 even during acceleration and transient phases.

Furthermore, non-return valves 56 are provided with a membrane 56′ and have a pin repulsor 57 to prevent the non-return valves from slipping out of their seat during the control fluid discharge phase. The presence of the pin, in fact, ensures that the membrane 56′ does not move from its seat as it is blocked by the pin 57.

With reference to FIGS. 4 and 6, a Teflon-coated glass 58 of the spool assembly 50 and a non-return valve 60, with discharge at very low opening back pressure, housed in the casing 70 of the positioner, have the function of making the value negligible and constant of the back pressure in the chamber 59 of the spring 61 of the spool 52, a back pressure which if present and variable would create problems when adjusting the position of the spool 52 as the resulting force would be added to the elastic force of the spring 61 which counteracts the axial force of the diaphragm 62. This measure is also necessary to improve the behavior of the spool in the presence of the high flow dynamics required by the positioner control unit.

If necessary, there is also the possibility of installing a speed limiter of the actuator, achieved through the mechanical reduction of the stroke of the spool 52 and, consequently, the reduction of the outflow coefficients of the positioner, both by loading and unloading. In this way, the air passage ports, both in loading and unloading, are not completely uncovered and therefore it is possible to simultaneously and proportionally limit the flow rate of working fluid from the positioner towards the actuator, both in loading and unloading, acting directly and exclusively on the positioner 10. Furthermore, it is possible to adjust the loading and unloading flow rate relating to only one direction of movement of the actuator without the adjustment of the other direction of movement of the actuator being influenced. It is therefore a double and independent adjustment of the direction of movement of the actuator. In this way, the following advantages are obtained:
it is possible to limit the maximum speed should a physical safety limit (not just software) be required at the maximum speed of movement in one of the two directions, being it certain not to influence the speed in the other direction,
by keeping the design characteristics of the positioner unchanged, a better control is obtained: stiffness and positioning resolution remain within their design ranges,
the positioner does not require throttling valves to regulate the control fluid, external to the positioner itself, which are difficult to regulate and which would not allow an optimal regulation of both the loading and unloading phases of the actuator.

The housing 70 of the positioner 10 has three pneumatic connections. Such casing 70 is made by casting and has a flat surface near the pneumatic connections, useful for connecting the positioner 10 to any manifold having front crush seals.

The lid 80 of the positioner 10 could have a seat 81 (as illustrated in FIG. 2) suitable for housing an element made of a transparent material. In this way it is possible, through a display and a capacitive keyboard installed in the component 82, both to display the process data and diagnostic data and to directly control the positioner 10, without using other devices or systems with dedicated software.

Finally, an interface and seal plate 90 can be provided between ECU 20 and the casing 70, which is essential for containing the pressure of the working fluid inside the casing passages and conveying the fluid flow towards the pressure sensors installed on the electronic board.

Ultimately, the positioner according to the present invention presents, compared to similar components and, in particular, compared to the positioner described in patent EP 2238377 B1, numerous technical measures which resolve the technical problems mentioned above.

In addition to the embodiments of the invention, as described above, it should be understood that numerous further variations exist. It must also be understood that said methods of implementation are only illustrative and do not limit either the object of the invention, or its applications, or its possible configurations. On the contrary, although the above description makes it possible for the skilled man to implement the present invention at least according to one of its exemplary configurations, it must be understood that numerous variations of the described components are conceivable, without thereby departing from the object of the invention, as defined in the attached claims, interpreted literally and/or according to their legal equivalents.

1. A valve positioner (10) for controlling a valve actuator comprising:
an electronic control unit (20) equipped with a microprocessor (25) which supplies a variable current signal to the positioner (10),
at least one position sensor group (30),
a transducer (40), configured to convert a current signal into a pressure signal,
a spool assembly (50) configured to move the working fluid to and from the actuator,
a casing (70) which contains the spool assembly (50) and the other components of the positioner and is provided with a plurality of openings for receiving and discharging air flowing from a plurality of fluid flow passages and with a discharge non-return valve (60), and
a lid (80), and
wherein said microprocessor (25) is provided with
at least one integrated memory of the Ferroelectric RAM type, and
a clock configured to assign a timing to recorded events and by the fact that the integrated memory is configured in such a way as to:
manage “big data” flows with high process dynamics,
manage “big data” flows and historical events with high sampling frequencies,
implement and perform diagnostic analyzes and statistical analyses.

2. The valve positioner (10) according to claim 1, wherein the electronic control unit (20) is configured so as to manage up to three independent pressure sensors.

3. The valve positioner (10) according to claim 2, wherein the electronic control unit (20) is configured so as to manage both a single-acting actuator and a double-acting actuator, without requiring any mechanical selection component.

4. The valve positioner (10) according to any of the preceding claims, wherein he electronic control unit (20) is provided with at least one port for managing the data coming from a contactless position sensor (32) of the magnetic type, belonging to the position sensor group (30).

5. The valve positioner (10) according to claim 1, wherein the electronic control unit (20) is also provided with a port for managing the data coming from a potentiometric position sensor.

6. The valve positioner (10) according to claim 4, wherein the position sensor assembly (30) includes a casing (31), a plate-like lid (35) and the contactless position sensor (32), contained in the casing (31) and kept in a predetermined position by a cylindrical sleeve stop (33) and a bottom stop (34).

7. The valve positioner (10) according to claim 1, wherein the transducer (40) is a contactless transducer of the magnetic type.

8. The valve positioner (10) according to claim 1, wherein the spool assembly (50) comprises a spool (52) provided with a stem (51) without guide bushings and of the floating type.

9. The valve positioner (10) according to claim 8, wherein a sleeve (54) covering the stem (51) of the spool (52) is provided with a smooth radially outer surface.

10. The valve positioner (10) according to claim 1, in which the spool assembly (50) is provided with non-return valves (56) equipped with a membrane (56′) and with a pin repulsor (57) which keeps the membrane (56′) in position.

11. The valve positioner (10) according to claim 1, wherein a Teflon-coated cup (58) of the spool assembly (50) and the exhaust non-return valve (60) are configured to ensure a negligible and constant backpressure in a chamber (59) of a spring (61) of the spool (52).

12. The valve positioner (10) according to claim 1, wherein an interface and sealing plate (90) is provided between the electronic control unit (20) and the spool assembly (50).
